(19) United States
(12) Patent Application Publication
(10) Pub. No.: US 2004/0190289 A1
(43) Pub. Date: Sep. 30, 2004

(54) Decorative lighting fixture and lighting string

(75) Inventor: Wen Li Liu, Shulin (TW)

Correspondence Address: MERCHANT & GOULD PC, P.O. BOX 2903, MINNEAPOLIS, MN, 55402-0903, US

(73) Assignees: Patty Barron; Tzu-Chen Liu; Warren Liu

(21) Appl. No.: 10/395,483

(22) Filed: Mar. 24, 2003

(51) Int. Cl. H01R 33/00

(52) U.S. Cl. 362/226; 362/267

(57) ABSTRACT

An improved lighting fixture for adaptation to an improved decorative lighting string is provided. A light bulb is inserted into the socket and the combined light bulb/socket assembly is combined with a socket base having a pair of electrical wires disposed therein. Use of a sealing and retaining ring provides for a snug and secure fit between the bulb and the socket. Engagement of complimentary slots of the socket base and alignment projections of the socket provide for improved orientation between the socket and the socket base and provide for an improved and more secure fit between the socket and the socket base. Engagement between a wedge-shaped skirt of the socket and a wedge-shaped recess of the socket base provides for a friction or snap fit between the socket and the socket base and prevents the introduction of moisture into the socket base. An end closure plug biases the electrical wires into a fixed position and closes a bottom end of the socket base to prevent the introduction of moisture or other foreign matter. Improved electrical contacts provide better conductivity though engagement with the leads of the bulb and are manufactured from an improved manufacturing process.

### FIELD OF THE INVENTION

The present invention generally relates to electrical lighting appliances. More particular, the present invention relates to an improved decorative lighting fixture and lighting string.

### BACKGROUND OF THE INVENTION

Since the beginning of the electrical age, it has become very popular to install decorative strings of electrical lighting fixtures as ornamentation to trees, shrubs, buildings, and a variety of objects. It has become particularly popular to decorate the exterior of a home or business related trees, shrubberies and the other plants during holiday periods.

A traditional decorative lighting string includes a plurality of small lighting fixtures wired together in an extended string that may be used to add decorative lighting to a structure or plant. Prior art lighting fixtures include a small light bulb inserted into a lightweight socket that is then connected to a central wire to provide electricity to the light bulb. Unfortunately, such lighting fixtures are typically quite fragile and are easily susceptible to failure. One problem associated with such prior art lighting fixtures is the introduction of moisture into the socket holding the light bulb which can cause a short circuit and failure of the fixture. Another problem associated with such prior art lighting fixtures includes a weak connection between the components of the lighting fixture, such as the connection between the light bulb and the corresponding socket holding the light bulb. Yet another problem associated with such prior art lighting fixtures includes inferior electrical contacts for providing electricity to a light bulb and the introduction of moisture into the lighting fixture at the location of entry of power supply wires into the lighting fixture.

It is with respect to these and other considerations that the present invention has been made.

### SUMMARY OF THE INVENTION

Embodiments of the present provide improved decorative lighting string. More particularly, embodiments of the present provide an improved lighting fixture for adaptation to an improved decorative lighting string.

Generally described, the present invention comprises a bulb, a lamp base and a lamp holder, wherein the light bulb penetrates through a hole in the center of the lamp base to make two lead-out wires underneath the bulb freely bend at 180 degree into U-shapes and lean against the glass of the bulb. A waterproof ring is convexly disposed on the outer bottom rim of the lamp base to tightly engage a waterproof ring concavely disposed in a proper area on the inner rim of the lamp holder thereby strengthening the assembly between the lamp base and the lamp holder and preventing the permeation of the moisture. The material used for a protruding corner on one side of two terminal copper tabs inside the lamp holder is obtained from one side of the other terminal copper tab thereby making the side of the terminal copper tabs have a cut corner through a complementary utilization without wasting the material. A waterproof plug is plugged in the space between two electric cords in the outlet area of the electric cords of the lamp holder to prevent the permeation of the moisture.

According to another aspect of the invention, a waterproof lighting fixture is provided. The fixture includes a light socket having a first receiving bore for telescopically receiving the male end of a light bulb. The socket has a retaining ring convexly disposed along an inner surface of the first receiving bore for engaging an outer surface of a light bulb that is telescopically inserted into the first receiving bore of the socket for holding the light bulb in position within the socket. The socket has a wedge-shaped annular skirt disposed convexly around an outer surface of a lower end of the socket. A socket base is provided having a second receiving bore for receiving a male end of the socket. The socket base has a wedge-shaped recess disposed circumferentially about an inner surface of the second receiving bore. When the socket is inserted into the second receiving bore of the socket base, the wedge-shaped skirt engages the wedge-shaped recess to form a waterproof seal to prevent entry of moisture into the second receiving bore of the socket base.

The socket may include a pair of alignment projections disposed along opposite sides of the socket in opposite spaced-apart orientation. The socket base may include a pair of complimentary alignment slots disposed along an upper edge of the socket base in opposite spaced-apart orientation. The alignment projections of the socket engage the alignment slots of the socket base when the socket is combined with the socket base such that engagement of the alignment projections with the alignment slots properly orients the socket to the socket base and secures the socket to the socket base.

The socket preferably includes a yoke for abutting a bottom end of the light bulb for cradling and stopping the light bulb at a fixed position. The yoke has an opening for communicating electrical leads disposed along the bottom of the light bulb. Attached to a bottom end of the socket is a pair of alignment arms positioned in 180° spaced-apart orientation. The socket base has a pair of 180° spaced-apart receiving slots disposed longitudinally along the second receiving bore of the socket base. When the socket and the socket base are combined, the alignment arms of the socket yoke engage the receiving slots of the socket base to properly orient the combination of the socket with the socket base and to secure the socket the socket base.

According to another aspect, the socket base includes a hingedly connected closure plug disposed at a bottom end of the socket base for closing the bottom end of the socket base and for positioning a pair of electrical wires inserted through the bottom end of the socket base for providing electricity to the light bulb. The closure plug is generally hour glass shaped and has a pair of arcuately-shaped indentions disposed along opposing sides of the closure plug for defining openings into the closure plug for allowing the pair of electrical wires to enter the socket base when the closure plug is in a closed position. When the closure plug is in a closed position, the arcuately-shaped indentions bias the electrical wires into a fixed position for preventing movement of the electrical wires relative to the bottom end of the socket base.

These and other features, advantages and aspects of the present invention may be more clearly understood and appreciated from a review of the following detailed description of the disclosed embodiments and by reference to the appended drawings and claims.

### BRIEF DESCRIPTION OF THE DRAWINGS

FIG. 1 is an exploded perspective view of a lighting fixture of the present invention showing all of the component parts in the order of their assembly.

FIG. 2 is a perspective view of a lighting fixture, similar to FIG. 1, with the wires and contacts inserted through the socket base via the open and unplugged access.

FIG. 3 is a similar exploded perspective view of a lighting fixture showing the wires rotated, retracted, and seated within dovetail slots in the socket base.

FIG. 4 is a perspective view of the assembled lighting fixture.

FIG. 5 is an exploded side elevation view of the component parts of the lighting fixture showing the relationship of the leads of the bulb as they are positioned above the socket with the contacts of the wires seated in the socket base.

FIG. 6 is a side elevation view of the assembled lighting fixture of FIG. 5.

FIG. 7 is a cross-sectional view taken along lines 7-7 in FIG. 6.

FIG. 8 is an enlarged top plan view of the socket base taken along lines 8-8 in FIG. 5.

FIG. 9 is a bottom plan view of the socket base showing the wire access plug open, allowing insertion of the wires with contacts to enter through a port having a major (horizontal) and minor (vertical) axis.

FIG. 10 is a bottom plan view of the socket base similar to FIG. 9, with the wires, shown in phantom lines, positioned and sealed within the bore via the closed plug which is attached to the socket base bottom via a live hinge.

FIG. 11 is an elevation view of a fragmentary section of a light string, wired in a series type electrical connection.

FIG. 12 is a schematic plan view of a conventional method of stamping or die cutting a plurality of electrical contacts having a saw-toothed barb on each side of each contact.

FIG. 13 is a schematic plan view of an improved method of fabricating the electrical contacts having a pattern that employs only one saw tooth and using the same arbitrary width as shown in FIG. 12.

### DETAILED DESCRIPTION OF THE PREFERRED EMBODIMENT

The following description of the embodiments for the present invention is made with reference to the above-described drawings wherein like numerals to refer to like parts or components throughout the several figures. The present invention is directed to an improved decorative lighting fixture and lighting sting.

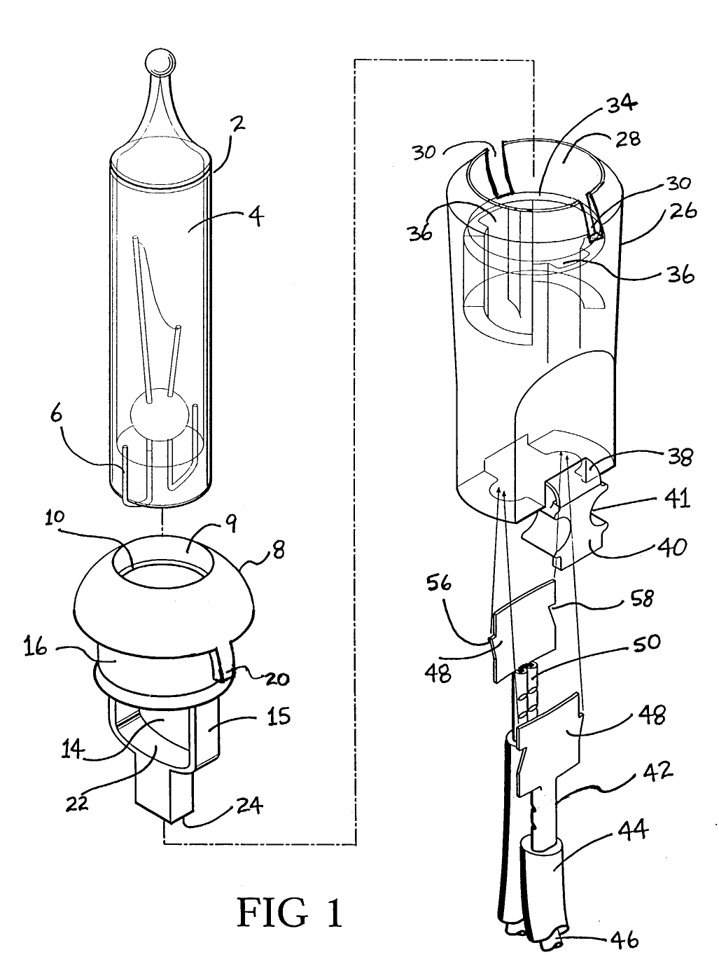

FIG. 1 is an exploded perspective view of a lighting fixture 1 showing all of the component parts in the order of their assembly with insulated electrical wires and contacts placed below an opening with a hinged access, and including a socket base 26, a light socket 8, and a light bulb 2. As shown in FIG. 1, a light bulb two having a cylindrical elongated body portion 4 is provided for providing light upon the provision of electrical power to a pair of flexible or bendable wire leads 6 extending from the exterior of the body portion 4 of the light bulb to the interior of the body portion for providing electrical power across a filament connecting ends of the leads 6. The two lead wires 6 of the light bulb 2 freely bend at 180 degrees into U-shapes to lean against the glass 4 of the bulb 2, as illustrated in FIG. 1. The light bulb 2 is manufactured from glass or plastic materials in a manner that is conventional and well known to those skilled in the art of manufacturing light bulbs for lighting fixtures.

A light socket or bulb base 8 is illustrated having a female receptor or bore 9 for telescopically receiving a lead or male end of the light bulb 2 for mating the light bulb 2 with the socket 8. The socket 8 may be manufactured from a variety of different materials and using a variety of different methods. According to embodiments of the present invention, the socket 8 is manufactured from polypropylene and is molded to form a unitary body requiring no sub-assembly. A sealing or retaining ring 10 is provided in the interior of the female receptor 9 for providing a friction fit between the bulb 2 and the socket 8 when the lead end of the bulb 2 is inserted into the socket 8.

A yoke 12 is connected to a bottom portion of the socket 8 that abuts against the bottom of the bulb 2 to act as a cradle and stop for the bulb when the bulb is communicated through the female receptor 9 of the socket 8 for connection of the bulb 2 to the socket 8. The yoke 12 includes an opening 14 to allow communication of the wire leads 6 to electrically engage a set of electrical contacts 48 in the socket base 26, described below. A wedge-shaped skirt 18 is provided about a lower end of a mid section 16 of the socket 8 for positive engagement with a moisture recess 34 of the socket base 26, described below, for providing a water proof seal between the socket 8 and the socket base 26 to prevent the introduction of moisture into the interior of the socket base 26 that may in turn create an electrical short circuit between a pair of electrical contacts 48.

Alignment projections 20 are disposed on opposite sides of the socket 8 and are defined for engagement with alignment slots 30 of the socket base 26 when the socket 8 is inserted into the socket base 26. Disposed along a lower end of the yoke 12 is a non-conductive tongue or projection 22 extending from the bottom portion of the yoke to form an insulating wall between a pair of electrical contacts 48, described below, to provide structural support between the contacts and to prevent electrical cross-conduction or spark gapping between the electrical contacts. A bottom end 24 of the yoke 12 is suited to abut against the insulation of the electrical wires 42 and to bias the wires 42 into a fixed position within the socket base 26.

The yoke 12 also includes a pair of elongate arms 15 for connecting a mid section 16 of the socket 8 to a tongue 22. According to an embodiment of the present invention, the elongate arms 15 serve to guide the socket 8 into engagement with the socket base 26 whereby the arms 15 are retained by a pair of oppositely disposed slots 36 in the socket base 26 for receiving the arms 15 and for providing additional connection strength and stability between the socket 8 and the socket base 26.

Referring still to FIG. 1, the socket base or lamp holder 26 is described. The socket base 26 may be manufactured from a variety of different materials and using a variety of different methods. According to embodiments of the present invention, the socket base 26 is manufactured from polypropylene and is molded to form a unitary body requiring no sub-assembly. The socket base 26 has a female receptor, cavity or bore 28 for receiving the male end 24 of the socket 8. The mid section of the cavity 28 is cylindrical and is dimensioned to telescopically receive an upper portion 16 of the socket 8. An annular wedge-shaped recess 34 is defined along the inter circumference of the cavity 28 for receiving the wedge-shaped annular skirt 18 of the socket 8.

A pair of alignment slots 30 that mate with corresponding alignment projections 20 of the socket 8 are disposed on opposite upper sides of the socket base 26 to assure correct orientation of the socket 8 to the socket base 26 and to provide a strong friction fit of the socket 8 to the socket base 26. When the socket 8 is engaged with the socket base 26, the wedge-shaped skirt 18 forms a friction or snap fit with the wedge-shaped recess 34 of the socket base 26 to strengthen the assembly between the socket base 26 and the socket 8 and to provide a waterproof connection between the socket base 26 and the socket 8 to prevent the introduction of moisture into the interior of the socket base 26. As briefly described above, a pair of receiving slots 36 are defined along opposite interior sides of the socket base 26 for receiving elongate alignment arms 15 of the yoke 12 of the socket 8. Engagement of the arms 15 with the receiving slots 36 allow for a proper orientation and mating of the socket 8 to the socket base 26 and provide additional strength and stability of the connection between the socket 8 and the socket base 26.

Disposed along a bottom edge of the socket base 26 is a closure plug 40. The closure plug 40 is connected to one side of the socket base 26 with a hinge 38 for allowing the closure plug 40 to swing to an open position as shown in FIG. 1 and to allow the introduction of electrical wires 42 into the bottom of the socket base 26. According to an embodiment of the present invention, the hinge 38 connecting the plug 40 to the socket base 26, is comprised of a weakened or scored section of the material from which the socket base 26 is made to allow the plug 40 to rotate about an axis formed by the hinge 38 to open or close.

A pair arcuately-shaped openings 41 are defined in the plug 40 for receiving a pair of electrical wires 42 when the plug 40 is placed in a closed position. According to an embodiment of the present invention, the plug 40 allows for the sealing of the bottom portion of the socket base 26 after the placement of the wires 42 through a bottom opening of the socket base 26. Use of the hinged plug 40 allows for a waterproof and structurally strong closure of the bottom end of the socket base 26 and biases the insulation 44 of the wires 42 into a fixed position to prevent movement of the wires once the plug is closed. Moreover, use of the closure plug 40 eliminates the necessity of the introduction of some other type closure material such as an epoxy resin or other sealant material.

As shown in FIG. 1 a pair of electrical wires 42 is illustrated for insertion into the bottom opening of the socket base 26 for providing electrical power to the bulb 2. The electrical wires 42 include insulated copper wires having insulation 44 and a central conductive copper wire 46. An electrical contact 48 is defined at the end of each wire 42 for providing electrical conductivity to the leads 6 of the light bulb 2 when the bulb is combined with the socket 8 and socket base 26. Each contact 48 has a protruding corner 56 disposed on one side and a corresponding cut corner 58 disposed on the other side. A lower end of each contact 48 is wrapped about and crimped to an exposed end of the electric wire 42. As will be described in detail below, the contacts 48 are stamped from copper stock and crimps 50 are provided for crimping an exposed end of the electrical wire 46 for providing electrical connectivity between the wire 46 and the contacts 48.

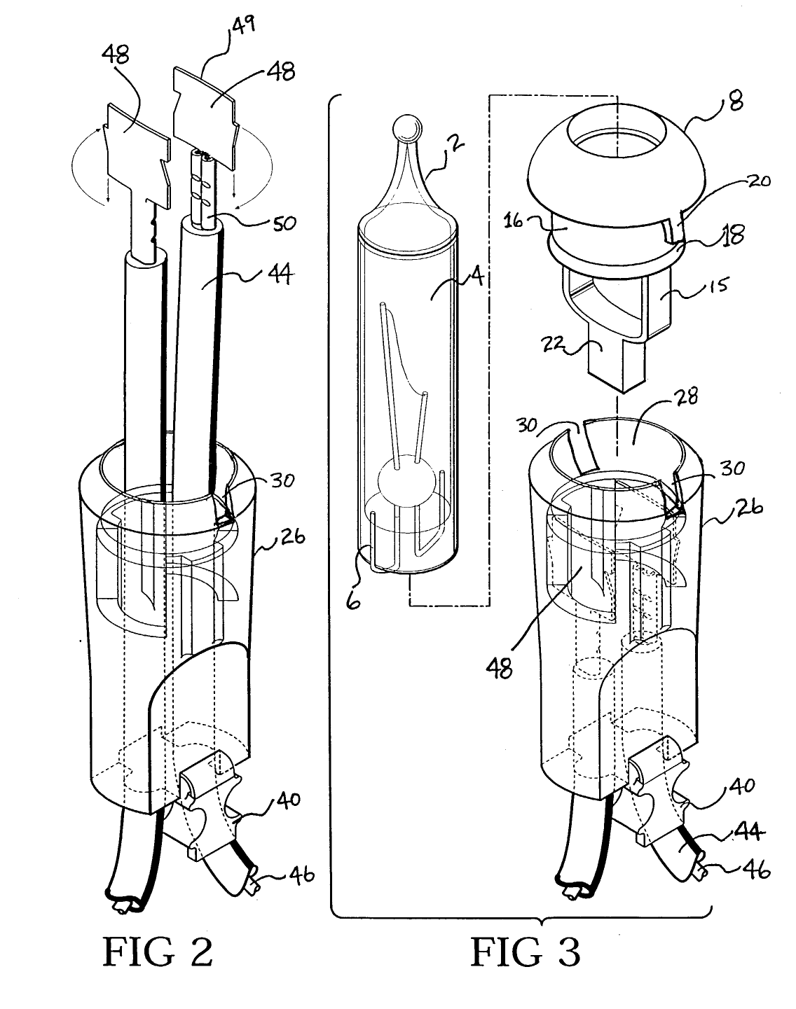

FIG. 2 is a perspective view of the lighting fixture 1 with the wires 42 and contacts 48 inserted through the socket base 26, via the open and unplugged access. As shown in FIG. 2, the electrical wires 42 are inserted through a bottom opening of the socket base 26. The illustration in FIG. 2 shows the wires 42 pulled through an upper portion of the socket base 26 to illustrate movement of the wires 42 through the central cavity or bore 28 of the socket base 26.

FIG. 3 is a similar exploded perspective view of the lighting fixture 1 showing the wires rotated, retracted, and seated within dovetail slots in the socket base 26. FIG. 3 illustrates another view of the bulb 2, socket 8 and socket base 26. The wires 42 are fixed along the interior bore 28 of the socket base 26. The contacts 48 are shown in phantom lines inside the socket base 26 in fixed positions on opposite sides of the interior portion of the socket base 26 for engagement with leads 6 of the bulb 2 for providing electricity to the bulb 2.

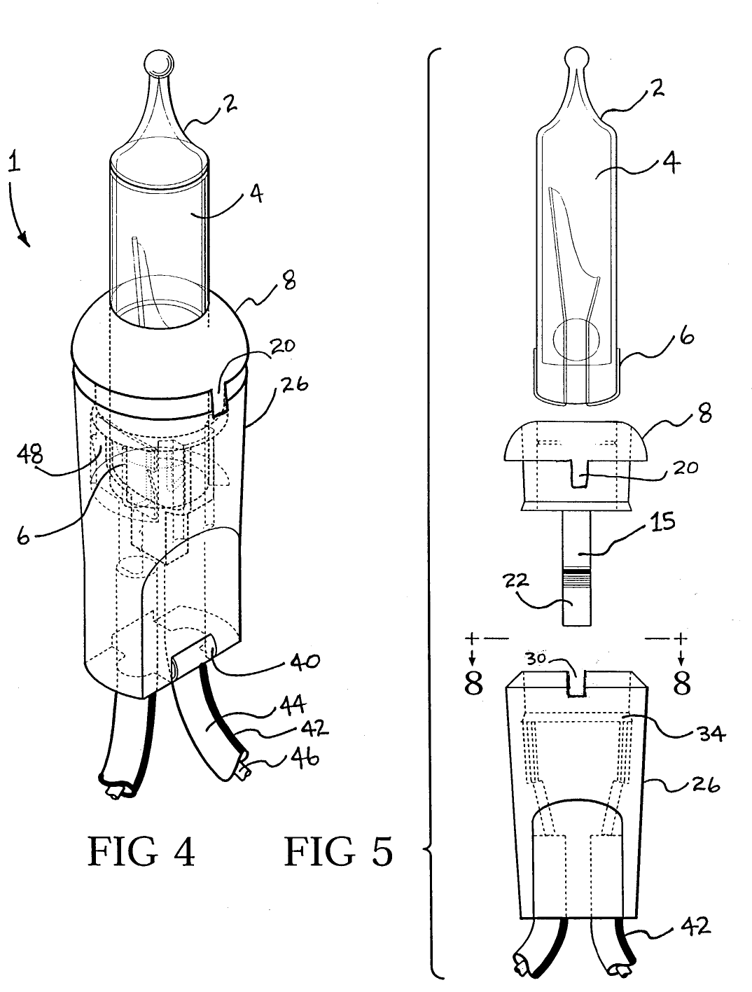

FIG. 4 is a perspective view of the assembled lighting fixture 1. As illustrative in FIG. 4, the bulb 2, the socket 8 and the socket base 26 are combined to form a lighting fixture 1. A portion of the outer surface of the bulb body 4 is in engagement with the sealing and retaining ring 10 within the inner bore of the socket 8 to tightly hold the bulb 2 in the socket 8 with a friction fit between the bulb 2 and the sealing and retaining ring 10. The wires 42 are shown inserted into the lower end of the socket base 26, and the closure plug 40 is shown a closed position. Shown in phantom lines in the interior of the socket base 26 are the leads 6 in engagement with the contacts 48.

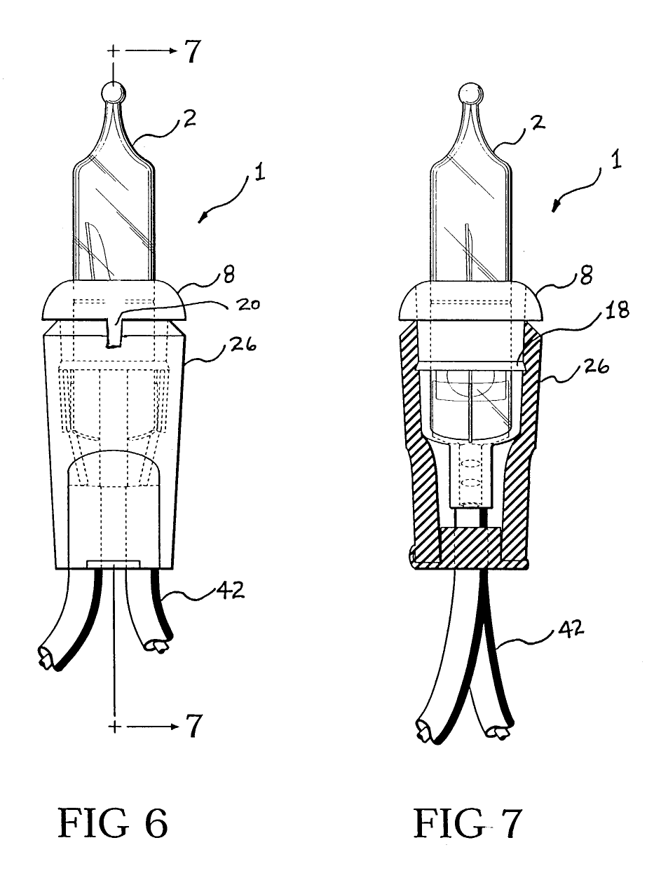

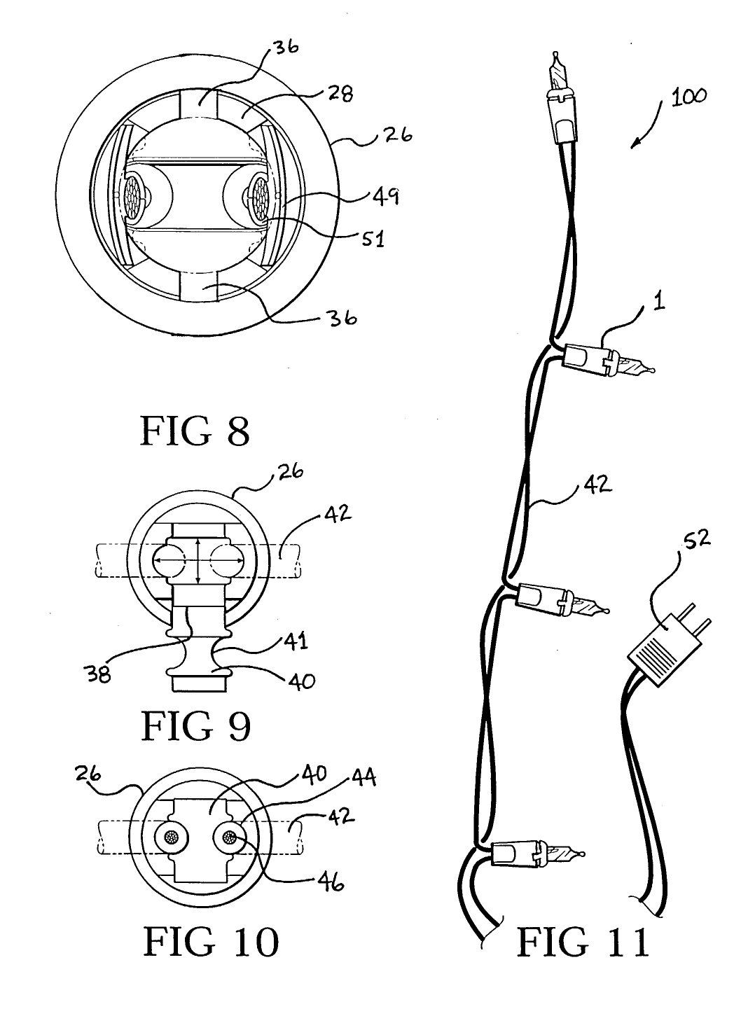

FIG. 5 is an exploded side elevation view of the component parts of the lighting fixture showing the relationship of the leads of the bulb as they are positioned above the socket with the contacts of the wires seated in the socket base. FIG. 6 is a side elevation view of the assembled lighting fixture of FIG. 5. FIG. 7 is a cross-sectional view taken along lines 7-7 in FIG. 6. FIG. 8 is an enlarged top plan view of the socket base 26 taken along lines 8-8 in FIG. 5. As shown in FIG. 8, upper edges 49 of the electrical contacts 48 and upper edges 51 of the crimps 50 are shown in a fixed position on opposite sides of the interior cavity 28 of the socket base 26. When the light bulb/socket assembly is connected to the socket base 26, the oppositely disposed leads 6 engage the upper edges 49 of the contacts 48 and bias the contacts 48 outward to allow the outer circumference of the lower male end of the bulb 2 to insert between the contacts 48 and to maintain positive and secure engagement between the leads 6 and the contacts 48.

FIG. 9 is a bottom plan view of the socket base showing the wire access plug 40 open to allow insertion of the wires 42 with contacts 48 in through a port (opening in the bottom of the socket base 26) having a major (horizontal) and minor (vertical) axis. FIG. 10 is a bottom plan view of the socket base 26 similar to FIG. 9 with the wires 42 shown in phantom lines positioned and sealed within the bore via the closed plug 40 that is attached to the socket base 26 bottom via the hinge 38.

FIG. 11 is an elevation view of a fragmentary section of a lighting string 100 wired in a series type electrical connection. As shown in FIG. 11, a number of assembled lighting fixtures 1 are wired together in series to obtain electrical conductivity between one another and to form a decorative string of lighting fixtures, described herein. An electrical plug 52 is disposed at one end of the decorative light string for providing electricity to the light string.

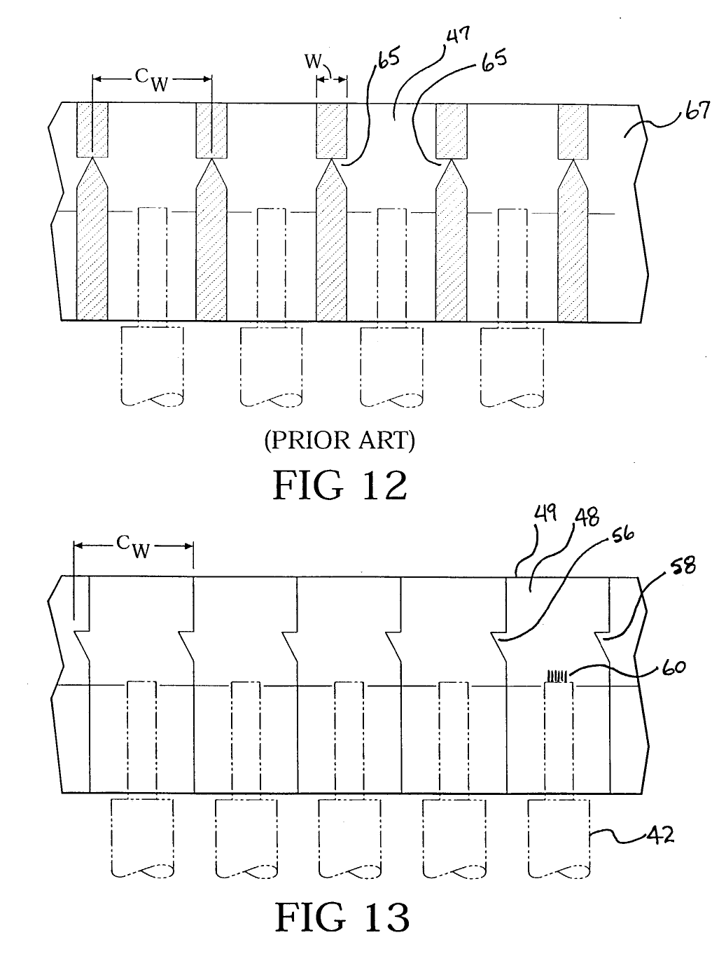

FIG. 12 is a schematic plan view of a conventional method of stamping or die cutting a plurality of electrical contacts 47. The contacts have a saw toothed barb 65 on each side. The contacts are stamped or cut from a web of material 67. The resulting loss of material associated with the prior art method shown in FIG. 12 as a shaded area between each contact is indicated as dimension W with an arbitrary contact width indicated at Cw. FIG. 13 is a schematic plan view of an improved method of fabricating the electrical contacts 48 having a pattern that employs only one saw tooth and using the same arbitrary width as shown in FIG. 12, indicated at Cw. The resulting design eliminates waste and renders a greater yield from a given web of material. According to an embodiment of the invention a preferred material for the contacts 48 is copper.

Referring to FIG. 13, the material used for the protruding corner 56 on one side of the terminal copper contact 48 is obtained from one side of the other terminal copper contact 48 as by making one side of the terminal copper contact 48 perform a cut corner 58 through a complimentary utilization, and therefore, reduce the loss of material during manufacture of the copper contacts, as illustrated with reference to FIG. 12. Because the contacts 48 and the copper wires 42 are wrapped in only one segment as compared to the two-segmented wrappings of the prior art contacts, illustrated in FIG. 12, with copper wires as well as insulating polyvinyl chloride bodies, the present embodiments saves material costs of the contacts 48 and is more economical and practical to manufacture.

As described above, an improved electrical lighting fixture I for adding to a decorative string 100 of lighting fixtures is disclosed. The light bulb 2 is inserted into the socket 8 and the combined light bulb/socket assembly is combined with a socket base 26 having a pair of electrical wires 42 disposed therein. Use of the sealing and retaining ring 10 provides for a snug and secure fit between the bulb 2 and the socket 8. Engagement of the complimentary slots 30 of the socket base 26 and the alignment projections 20 provide for improved orientation between the socket 8 and the socket base 26 and provide for an improved and more secure fit between the socket 8 and the socket base 26. Engagement between the wedge-shaped skirt 18 of the socket 8 and the wedge-shaped recess 34 of the socket base 26 provides for a friction or snap fit between the socket 8 and the socket base 26 and prevents the introduction of moisture into the socket base 26.

The end closure plug 40 biases the electrical wires 42 into a fixed position and closes a bottom end of the socket base 26 to prevent the introduction of moisture or other foreign bodies. The improved electrical contacts 48 provide better conductivity though engagement with the lead 6 of the bulb 2 and are manufactured from an improved manufacturing process. It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

We claim:

1. A waterproof lighting fixture, comprising:
a socket having a first receiving bore for telescopically receiving the male end of a light bulb;
said socket having a retaining ring convexly disposed along an inner surface of the first receiving bore for engaging an outer surface of a light bulb telescopically inserted into the first receiving bore of the socket for holding the light bulb in position within the socket;
said socket having a wedge-shaped annular skirt disposed convexly around an outer surface of a lower end of said socket;
a socket base having a second receiving bore for receiving a male end of the socket;
said socket base having a wedge-shaped recess disposed circumferentially about an inner surface of the second receiving bore; and
whereby when said socket is inserted into the second receiving bore of said socket based, said wedge-shaped skirt engages said wedge-shaped recess to form a waterproof seal to prevent entry of moisture into the second receiving bore of said socket base.

2. The waterproof lighting fixture of claim 1;
whereby said socket further comprises a pair of alignment projections disposed along opposite sides of said socket in opposite spaced-apart orientation;
whereby said socket base further comprises a pair of alignment slots disposed along an upper edge of said socket base in opposite spaced-apart orientation; and
whereby said pair of alignment projections of said socket engage said alignment slots of said socket base when said socket is combined with said socket base such that engagement of said alignment projections with said alignment slots properly orients said socket to said socket base and secures said socket to said socket base.

3. The waterproof lighting fixture of claim 1;
whereby said socket further comprises a yoke for abutting a bottom end of said light bulb for cradling and stopping said light bulb at a fixed position;
said yoke having an opening for communicating electrical leads disposed along the bottom of said light bulb;
said yoke attached to a bottom end of said socket by a pair of alignment arms positioned in 180° spaced-apart orientation;
said socket base having a pair of 180° spaced-apart receiving slots disposed longitudinally along the second receiving bore of said socket base; and
whereby when said socket and said socket base are combined, said alignment arms of said socket yoke engage said receiving slots of said socket base to properly orient the combination of said socket with said socket base and to secure said socket to said socket base.

4. The waterproof lighting fixture of claim 3, whereby said yoke further comprises a tongue extending from a bottom edge of said yoke for separating and insulating a pair of electrical contacts inserted into the second receiving bore of the socket base.

5. The waterproof lighting fixture of claim 1, further comprising a pair of space-apart electrical contacts crimped to a pair of electrical wires, said contacts for engaging a pair of electrical leads of said light bulb, said pair of spaced-apart electrical contacts secured along an inner surface of the second receiving bore of the socket base.

6. The waterproof lighting fixture of claim 5, whereby said socket base further comprises a hingedly connected closure plug disposed at a bottom end of said socket base for closing the bottom end of said socket base and for positioning a pair of electrical wires inserted through the bottom end of said socket base for providing electricity to said light bulb.

7. The waterproof lighting fixture of claim 6, whereby said closure plug is generally hour glass shaped having a pair of arcuately-shaped indentions disposed along opposing sides of said closure plug for defining openings into said closure plug for allowing the pair of electrical wires to enter said socket base when said closure plug is in a closed position.

8. The waterproof lighting fixture of claim 7, whereby when said closure plug is in a closed position, said arcuately-shaped indentions bias said electrical wires into a fixed position for preventing movement of said electrical wires relative to the bottom end of said socket base.

9. The waterproof lighting fixture of claim 5,
whereby each contact of the pair of contacts has a protruding corner disposed on one side each contact and a corresponding cut corner disposed on the other side of each contact and whereby a lower end of each contact is wrapped about and crimped to an exposed end of an electric wire.

10. A waterproof lighting fixture, comprising:
a socket having a first receiving bore for telescopically receiving the male end of a light bulb;
said socket having a retaining ring convexly disposed along an inner surface of the first receiving bore for engaging an outer surface of a light bulb telescopically inserted into the first receiving bore of the socket for holding the light bulb in position within the socket;
said socket having a pair of alignment projections disposed along opposite sides of said socket in opposite spaced-apart orientation;
said socket having a wedge-shaped annular skirt disposed convexly around an outer surface of a lower end of said socket;
a socket base having, a second receiving bore for receiving a male end of the socket;
said socket base having a wedge-shaped recess disposed circumferentially about an inner surface of the second receiving bore;
said socket base having a pair of alignment slots disposed along an upper edge of said socket base in opposite spaced-apart orientation;
whereby said pair of alignment projections of said socket engage said alignment slots of said socket base when said socket is combined with said socket base such that engagement of said alignment projections with said alignment slots properly orients said socket to said socket base and secures said socket to said socket base; and
whereby when said socket is inserted into the second receiving bore of said socket based, said wedge-shaped skirt engages said wedge-shaped recess to form a waterproof seal to prevent entry of moisture into the second receiving bore of said socket base.

11. The waterproof lighting fixture of claim 10;
whereby said socket further comprises a yoke for abutting a bottom end of said light bulb for cradling and stopping said light bulb at a fixed position;
said yoke having an opening for communicating electrical leads disposed along the bottom of said light bulb;
said yoke attached to a bottom end of said socket by a pair of alignment arms positioned in 180° spaced-apart orientation;
said socket base having a pair of 180° spaced-apart receiving slots disposed longitudinally along the second receiving bore of said socket base; and
whereby when said socket and said socket base are combined, said alignment arms of said socket yoke engage said receiving slots of said socket base to properly orient the combination of said socket with said socket base and to secure said socket to said socket base.

12. The waterproof lighting fixture of claim 10, further comprising a pair of space-apart electrical contacts crimped to a pair of electrical wires, said contacts for engaging a pair of electrical leads of said light bulb, said pair of spaced-apart electrical contacts secured along an inner surface of the second receiving bore of the socket base, whereby each contact of the pair of contacts has a protruding corner disposed on one side each contact and a corresponding cut corner disposed on the other side of each contact and whereby a lower end of each contact is wrapped about and crimped to an exposed end of an electric wire.

13. The waterproof lighting fixture of claim 10, whereby said socket base further comprises a hingedly connected closure plug disposed at a bottom end of said socket base for closing the bottom end of said socket base and for positioning a pair of electrical wires inserted through the bottom end of said socket base for providing electricity to said light bulb.

14. The waterproof lighting fixture of claim 13, whereby said closure plug is generally hour glass shaped having a pair of arcuately-shaped indentions disposed along opposing sides of said closure plug for defining openings into said closure plug for allowing the pair of electrical wires to enter said socket base when said closure plug is in a closed position.

15. A waterproof lighting fixture, comprising:
a socket having a first receiving bore for telescopically receiving the male end of a light bulb;
said socket having a retaining ring convexly disposed along an inner surface of the first receiving bore for engaging an outer surface of a light bulb telescopically inserted into the first receiving bore of the socket for holding the light bulb in position within the socket;
said socket having a wedge-shaped annular skirt disposed convexly around an outer surface of a lower end of said socket;
a socket base having a second receiving bore for receiving a male end of the socket;
said socket base having a wedge-shaped recess disposed circumferentially about an inner surface of the second receiving bore;
said socket base having a hingedly connected closure plug disposed at a bottom end of said socket base for closing the bottom end of said socket base and for positioning a pair of electrical wires inserted through the bottom end of said socket base for providing electricity to said light bulb; and
whereby when said socket is inserted into the second receiving bore of said socket based, said wedge-shaped skirt engages said wedge-shaped recess to form a waterproof seal to prevent entry of moisture into the second receiving bore of said socket base.

16. The waterproof lighting fixture of claim 15;
whereby said socket further comprises a pair of alignment projections disposed along opposite sides of said socket in opposite spaced-apart orientation;
whereby said socket base further comprises a pair of alignment slots disposed along an upper edge of said socket base in opposite spaced-apart orientation; and
whereby said pair of alignment projections of said socket engage said alignment slots of said socket base when said socket is combined with said socket base such that engagement of said alignment projections with said alignment slots properly orients said socket to said socket base and secures said socket to said socket base.

17. The waterproof lighting fixture of claim 15;
whereby said socket further comprises a yoke for abutting a bottom end of said light bulb for cradling and stopping said light bulb at a fixed position;
said yoke having an opening for communicating electrical leads disposed along the bottom of said light bulb;
said yoke attached to a bottom end of said socket by a pair of alignment arms positioned in 180° spaced-apart orientation;
said socket base having a pair of 180° spaced-apart receiving slots disposed longitudinally along the second receiving bore of said socket base; and
whereby when said socket and said socket base are combined, said alignment arms of said socket yoke engage said receiving slots of said socket base to properly orient the combination of said socket with said socket base and to secure said socket to said socket base.

18. The waterproof lighting fixture of claim 15, further comprising a pair of space-apart electrical contacts crimped to a pair of electrical wires, said contacts for engaging the pair of electrical leads of said light bulb, said pair of spaced-apart electrical contacts secured along an inner surface of the second receiving bore of the socket base.

19. The waterproof lighting fixture of claim 18, whereby said closure plug is generally hour glass shaped having a pair of arcuately-shaped indentions disposed along opposing sides of said closure plug for defining openings into said closure plug for allowing the pair of electrical wires to enter said socket base when said closure plug is in a closed position.

20. The waterproof lighting fixture of claim 19, whereby when said closure plug is in a closed position, said arcuately-shaped indentions bias said electrical wires into a fixed position for preventing movement of said electrical wires relative to the bottom end of said socket base.
